(19) United States
(12) Patent Application Publication
(10) Pub. No.: US 2005/0050873 A1
(43) Pub. Date: Mar. 10, 2005

(54) Tractor mountable brush cutting device

(76) Inventor: Allan D. Rookes, St. Lazare (CA)

Correspondence Address: ADE & COMPANY, 1700-360 MAIN STREET, WINNIPEG, MB, R3C3Z3, CA

(21) Appl. No.: 10/655,596

(22) Filed: Sep. 5, 2003

(51) Int. Cl. A01D 34/64

(52) U.S. Cl. 56/14.7

(57) ABSTRACT

A vehicle mountable cutting device comprising a mounting arrangement arranged to be coupled to the existing bucket mount arrangement on a vehicle, a housing arranged to extend out to one side of the vehicle. A cutting mechanism on an outer end of the housing, and an extending arrangement on the housing arranged such that the cutting mechanism can be extended inwards and outwards relative to the vehicle.

### FIELD OF THE INVENTION

The present invention relates to a bush cutting device arranged to be mounted to a tractor.

### BACKGROUND

Cutting shrubs, trees and brush along fence lines and the like can prove to be an arduous chore. Commonly, a person has to walk along the fence line with a chain saw or similar type cutting tool and manually cut away the brush and the like.

There are some mechanisms which can be mounted to tractors or the like for cutting. These examples are shown in U.S. Pat. No. 5,901,538 (Vohl), U.S. Pat. No. 4,946,488 (Davison), U.S. Pat. No. 4,802,327 (Roberts) and U.S. Pat. No. 4,769,977 (Milbourn).

The patent of Vohl provides rigid blades which may not be suitable for cutting in areas with stones or other solid objects. Skids or wheels on the side of the device may not allow the blades to get close to fences. Deflecting bars on the device may direct all brush to the centre where the brush would be ran over by the vehicle powering the cutter.

The patent of Davison has a solid steel blade which if it were to come in contact with a solid object such as a stone or piece of steel it may cause serious damage to the cutter. There is no description of a push bar to keep objects from falling on the vehicle and would be difficult to use in areas where a manicured look is required. The leading edge of the cutter does not appear to have the ability to cut which causes questions as to its effectiveness to fell larger trees without binding.

Roberts discloses a chain saw blade with will not cut grass very effectively. The design of the blade may not allow for cutting larger brush since the disk is larger than the kerf of the chain. Also, larger brush may cause the disk to jam on larger diameter trees.

Milbourn has a device in which the size of the machine that carries the apparatus can limit the cost effectiveness to many people wanting to use this type of device. This device would work well on large trees where thy are a problem but may not work well on grass and small shrubs where manicured look would be essential such as around fences, orchards or tree farms where maintenance around small trees or shrubs is required. The rigid cutter blades would be damaged if it came into contact with stones or other hard objects. Also, the rigidity of the blades may cause them to have a tendency to hurl objects that they come in contact with. The tracked vehicle could also cause damage to the landscape in places where it may have to turn, limiting its use in parks, golf courses, etc..

### SUMMARY

It is one object of the present invention to provide a cutting device for brush and the like.

According to a first aspect of the invention there is provided a tractor mountable cutting device comprising:
a mounting arrangement arranged to be coupled to the existing bucket mount arrangement on a tractor;
a housing arranged to extend out to one side of the tractor;
a cutting mechanism on an outer end of the housing, and;
an extending arrangement on the housing arranged such that the cutting mechanism can be extended inwards and outwards relative to the tractor.

Preferably the housing comprises a body having mounting members arranged for attachment to the mounting arms of the tractor such that the body extends at right angles to a direction of movement of the tractor.

Preferably the housing comprises an elongate body extending at right angles to the direction of movement.

Preferably the extending arrangement comprises a slide member movable along the elongate housing.

Preferably the slide member carries at its outer end the cutting mechanism and a motor for driving the cutting mechanism.

Preferably the cutting mechanism includes a generally semi circular cover over a rear part of the cutting mechanism.

Preferably a front edge of the cover extends outwardly and rearwardly from the end of the slide member.

Preferably the cover includes a skirt around a rear part.

According to a second aspect of the invention there is provided a skid steer loader mountable cutting device comprises:
a mounting arrangement arranged to be coupled to the existing bucket mount arrangement on a skid steer loader;
a housing arranged to extend forwardly and outwardly out to one side of the skid steer loader, and;
a cutting mechanism on an outer end of the housing arranged such that the cutting arrangement is controlled by movement of the skid steer loader.

Preferably the mounting arrangement comprises a vertical plate for attachment to the bucket mount of the loader, a horizontal plate extending forwardly and outwardly from the vertical plate and at least one brace which connects the plates.

Preferably the cutting mechanism includes a generally semi circular horizontal cover over a rear part of the cutting mechanism.

Preferably a front edge of the cover extends outwardly and rearwardly from the end.

Preferably the cover includes a skirt around a rear part.

The present invention provides thus a heavy duty brush and tree cutter which can be converted to cut grass and shrubs around objects that would be damaged by rotating blades or flails such as wood or concrete foundations. With the optional flails attached to the cutter and its low profile it is suited for heavy cutting under fence lines where growth has made it impossible to maintain the fence properly. The flails swing freely on a pivot pin, which allows them to fold back in case they come into contact with immovable objects such as stones, which may not be seen by the operator in heavy brush or thick grass. Since flails work even if they are somewhat blunted, chips and notches out of the leading edge would not impede its ability to keep working.

In extreme stony terrain the flail blades can be replaced with chain that will allow flails to contact rocks with no damage to the machine. In cases where a gentle but effective cut is required such as around foundations of cement and wood or along chain link fences, a UHMW (heavy plastic) attachment can be used to give the results of the small hand held trimmers.

The cutter attaches in minutes to any vehicle with a front end loader and can be suited to any vehicle with few modifications. The position of the cut range is only limited by the movement of the vehicle.

With the cutters mount position on the front of the vehicle and off to one side the machine supplying the drive parallel to the object of the cutter with the operator looking ahead some machines would have to be driven forward and then reversed if they were mounted in the centre or the machine.

The cutter is also supplied with a push bar to allow felled trees to be forced forward as they are cut to keep them from falling on the vehicle. This bar is situated so that it goes over the wire while the cutter goes under the wire. This allows trees cut on the opposite side of the fence to be forced to fall away from the fence and not on top of the wire.

### BRIEF DESCRIPTION OF THE DRAWINGS

In the accompanying drawings, which illustrate an exemplary embodiment of the present invention:

FIG. 1 is a top plan view of one embodiment of the present invention.

FIG. 2 is a side elevational view of the embodiment as shown in FIG. 1.

FIG. 3 is a top plan view of a second embodiment of the present invention.

FIG. 4 is a side elevational view of the embodiment as shown in FIG. 3.

### DETAILED DESCRIPTION

Referring to the accompanying drawings, there is illustrated a vehicle mountable cutting arrangement 1. The vehicle is illustrated as a tractor and the invention is generally to be used on a tractor but not restricted to use on a tractor. The saw is arranged to cut along fence lines and the like clearing away unwanted brush and small trees.

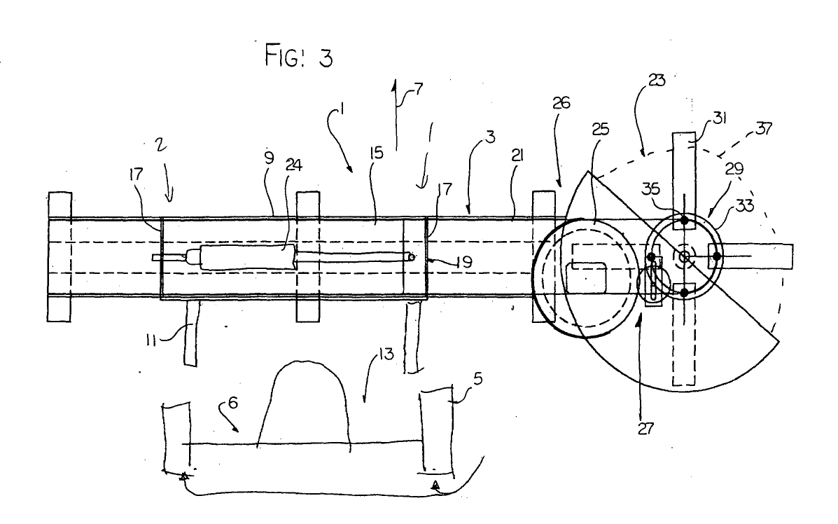

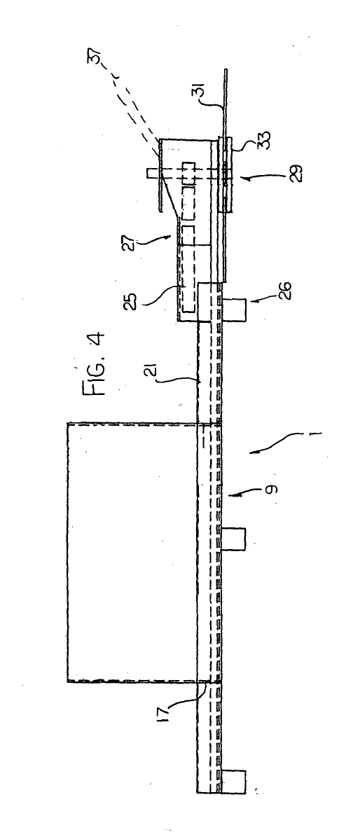

In a first embodiment of the cutting arrangement, as illustrated in FIG. 3 and 4, there is a housing 3. The housing is elongate and arranged to be mounted to the existing loader mount arms 5 on a tractor 6. The housing is mounted generally perpendicular to the general direction of the travel, indicated by arrow 7, of the tractor. The housing has a first section 9 which has corresponding mounting portions 11. The mounting portions vary for different type of tractor arranged such that the mounting portions correspond with the bucket mounting arrangement 13 of the tractor. The first section has a hollow interior 15 and each end 17 of the first section has an opening 19 such that the first section is arranged to receive a second inner section 21. The inner section is arranged to slide horizontally within the first section providing side to side movement of the inner section. The inner section is elongate and has substantial length such that an end can be extended beyond the side of the tractor. The inner section extends out to one side of the tractor and with the sliding movement can be extended inwards and outwards relative to the side of the tractor. The inner section is moved by a hydraulic cylinder 24 arranged to be controlled by the operator of the tractor such that the inner section slides inwards and outwards in the first section.

A flail type cutting mechanism 23 is arranged to be mounted to a outermost end 26 of the inner section. The cutting mechanism is arranged to engage brush, shrubs and trees, specifically along a fence line or the like. The position of the cutting mechanism is controlled by the user in that the operator can move the cutting mechanism inward or outward depending on the terrain. The cuffing mechanism is driven by a hydraulic motor 25 which is mounted on the inner section. A pulley arrangement 27 is provided to connect the hydraulic motor to a blade arrangement 29. The blade arrangement has a plurality of cutting blades 31 which are connected to a rotating plate 33 which is thereby driven by the hydraulic motor through the pulley arrangement. The blades are rotatably mounted to plate such that the blades rotate freely about the axis of the plate.

The blade arrangement can be converted to cut grass and shrubs around objects that would be damaged by rotating blades or flails such as wood or concrete foundations. With the optional flails attached to the cutter and its low profile it is suited for heavy cutting under fence line where growth has made it impossible to maintain fence properly. The flails swing freely on a pivot pin 35, which allows them to fold back in case they come into contact with immovable objects such as stones which may not be seen by the operator in heavy brush or thick grass. Flails work even if they are somewhat blunted or if chips or notches are taken out of the leading edge.

In extreme stony terrain the flail blades can be replace with a chain that allows flails to contact rocks with no damage to the machine.

In cases where a gentle but effective cut is required such as around foundations of cement and wood or along chain link fences, a UHMW (heavy plastic) attachment can be used to give the results of a small hand held gas powered trimmer.

The cutter attaches in minutes to any vehicle with a front end loader and can be suited to any vehicle with few modifications. The position of the cut range is only limited by the movement of the loader.

With the cutter mounting position on the front of the vehicle and off to one side or the other, the machine supplying the drive parallel to the object of the cutter with the operator looking ahead some machines would have to be driven forward and then reversed if they were mounted in the centre of the machine.

The cutter is also supplied with a push bar 37 to allow felled tress to be forced forward as they are cut to keep them from falling on the vehicle. This bar is situated so that it goes over the wire while the cutter goes under the wire. This allows trees cut on the opposite side of the fence to be forced to fall away from the fence and not on top of the wire.

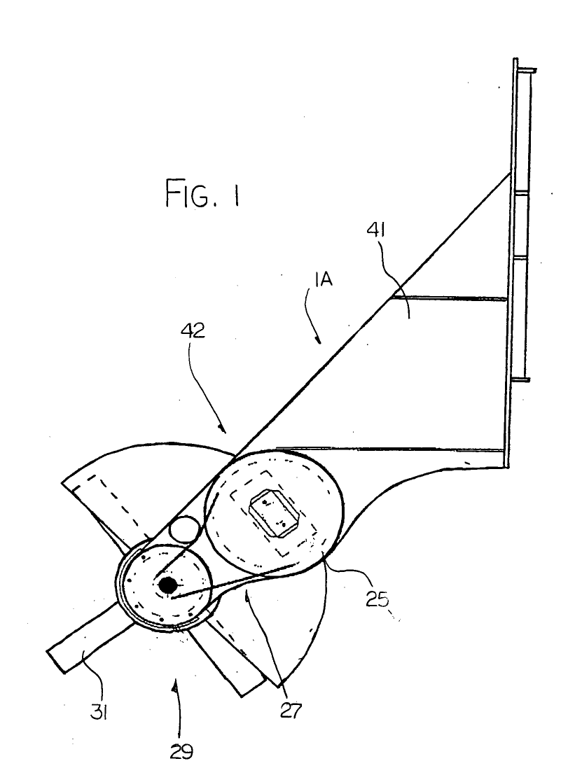

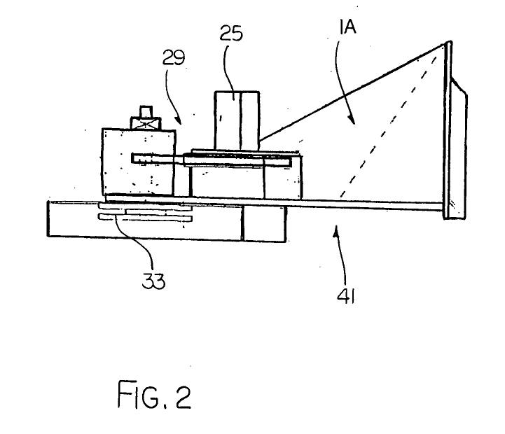

In a second embodiment of the present invention, as shown in FIG. 1 and 2, a housing 1A is designed specifically for mounting on skid steer type loaders. The housing is a rigid arm 41 which extends forwardly and outwardly to one side of the skid steer loader. The blade mechanism is located at an outermost end 42 of the housing and the position of the blade mechanism is controlled by the position of the skid steer loader. It is possible to use this type of cutting arrangement on a skid steer loader due to the precise handling of the loader. The first embodiment, as shown in FIGS. 3 and 4, is specifically for larger less mobile loader type vehicles.

While one embodiment of the present invention has been described in the foregoing, it is to be understood that other embodiments are possible within the scope of the invention. The invention is to be considered limited solely by the scope of the appended claims.

1. A combination of a vehicle and a cuffing device mounted thereon comprising:
a vehicle having a bucket mount for a front end loading bucket;
a mounting arrangement arranged to be coupled to the existing bucket mount of the vehicle;
a housing carried on the mounting arrangement in the form of an elongate body so as to extend with a longitudinal direction of the housing across a front of the vehicle at right angles to a direction of movement of the vehicle and out to one side of the vehicle;
an extending slide member mounted on the housing for sliding movement along the longitudinal direction of the housing;
a cutting mechanism mounted on an outer end of the slide member for rotation about generally upstanding axis for rotation of cutting members thereof about the upstanding axis;
a motor for driving the cutting mechanism mounted on the slide member adjacent its outer end;
a generally semi circular cover over a rear part of the cutting mechanism leaving a front part of the cutting mechanism, expose for cutting material standing on the ground as the vehicle moves forwardly over the ground;
and an actuator for effecting sliding movement of the slide member along the housing and arranged such that the cutting mechanism can be extended inwards and outwards relative to the vehicle.

2. (Cancelled)

3. (Cancelled)

4. (Cancelled)

5. (Cancelled)

6. (Cancelled)

7. The combination according to claim 1 wherein a front edge of the cover extends outwardly and rearwardly from the end of the slide member.

8. The combination according to claim 8 wherein the cover includes a skirt around a rear part.

9. A combination of a skid steer loader vehicle and a cutting device mounted thereon comprising:
a skid steer loader having a bucket mount for mounting a front end loading bucket;
a mounting arrangement arranged to be coupled to the existing bucket mount of the skid steer loader vehicle;
a housing having a vertical plate for attachment to the bucket mount of the skid steer loader vehicle;
a cutting mechanism mounted on the housing for rotation about generally upstanding axis for rotation of cutting members about the upstanding axis;
a motor for driving the cutting mechanism mounted on the housing adjacent an outer end;
a generally semi circular cover over a rear-art of the cutting mechanism leaving a front Dart of the cutting mechanism exposed for cutting material standing on the ground as the skid steer loader vehicle moves forwardly over the ground;
the housing Including a rigid arm which extends from the vertical plate forwardly and outwardly out to a position extending outwardly from one side of the skid steer loader vehicle, and;
the rigid arm supporting the cutting mechanism on an outer end of the housing at a fixed position relative to the vertical plate such that the position on the around of the cutting mechanism is controlled by steering movement of the skid steer loader vehicle.

10. The combination according to claim 9 wherein the rigid arm comprises a horizontal plate extending forwardly and outwardly from the vertical plate and at least one brace which connects the vertical plate and the horizontal plate.

11. (Cancelled)

12. The combination according to claim 9 wherein a front edge of the cover extends outwardly and rearwardly from the end of the slide member.

13. The combination according to claim 9 wherein the cover includes a skirt around a rear part.

14. The combination according to claim 9 wherein the cutting mechanism includes a push bar located at the cutter members and arranged at a position above the cutter members such that when approaching a horizontal wire the push bar goes over the wire while the cutter members go under the wire.

15. A combination of a vehicle and a cutting device mounted thereon comprising:
a vehicle having a bucket mount for a front end loading bucket;
a mounting arrangement arranged to be coupled to the existing bucket mount of the vehicle;
a housing carried on the mounting arrangement in the form of an elongate body so as to extend with a longitudinal direction of the housing across a front of the vehicle at right angles to a direction of movement of the vehicle and out to one side of the vehicle;
an extending slide member mounted on the housing for sliding movement along the longitudinal direction of the housing;
a cutting mechanism mounted on an outer end of the slide member for rotation about generally upstanding axis for rotation of cutting members thereof about the upstanding axis;
a motor for driving the cutting mechanism mounted on the slide member adjacent its outer end;
a generally semi circular cover over a rear part of the cutting mechanism leaving a front part of the cutting mechanism exposed for cutting material standing on the ground as the vehicle moves forwardly over the ground;
an actuator for effecting sliding movement of the slide member along the housing and arranged such that the cutting mechanism can be extended inwards and outwards relative to the vehicle;
the cutting mechanism including a push bar located at the cutter members and arranged at a position above the cutter members such that when approaching a horizontal wire the push bar goes over the wire while the cutter members go under the wire.
